(19) United States
(12) Patent Application Publication
(10) Pub. No.: US 2024/0397272 A1
(43) Pub. Date: Nov. 28, 2024

(54) METHOD FOR OPERATING A SMART MOBILE DEVICE, HEARING DEVICE AND HEARING SYSTEM

(71) Applicant: Sivantos Pte. Ltd., Singapore (SG)

(72) Inventors: Michael BLENDINGER, Erlangen (DE); Andreas PFROMMER, Erlangen (DE); Subhasri MITRA, Erlangen (DE)

(21) Appl. No.: 18/675,961

(22) Filed: May 28, 2024

(30) Foreign Application Priority Data
May 26, 2023 (DE) 10 2023 204 981.3

(51) Int. Cl. H04R 25/00

(52) U.S. Cl. CPC H04R 25/554; H04R 2225/0216; H04R 2225/55

(57) ABSTRACT

A method for operating a smart mobile device. The method includes checking for or ascertaining the presence of a device known to the mobile device by way of a radio module in a locked state of the mobile device, in which manual access to the data content thereof is disabled. In the event that the presence of the known device is detected, an ultra-wideband radio connection is used to ascertain whether the known device is within a predefined distance from the mobile device. The locked state of the mobile device is canceled if the known device is within the predefined distance.

The invention relates to a method for operating a smart mobile device. In addition, the invention relates to a hearing apparatus and a hearing system.

Hearing apparatuses are normally used to output an audio signal to the hearing of the wearer of this hearing apparatus. The output is provided by means of an output transducer, usually acoustically by way of airborne sound by means of a loudspeaker (also referred to as a “receiver”). Such hearing apparatuses are often used as so-called hearing aids (also shortened to: hearing devices). To this end, the hearing apparatuses usually comprise an acoustic input transducer (in particular a microphone) and a signal processor, which is configured to use at least one signal processing algorithm, normally stored on a user-specific basis, to process the input signal (also: microphone signal) generated by the input transducer from the ambient sound in such a way that a hearing loss of the wearer of the hearing apparatus is at least partially compensated for. In particular in the case of a hearing aid, the output transducer may be not only a loudspeaker but also alternatively a so-called bone conduction receiver or a cochlear implant, which are configured to mechanically or electrically couple the audio signal into the hearing of the wearer. The term “hearing apparatuses” additionally covers in particular also devices such as e.g. so-called tinnitus maskers, headsets, headphones and the like.

Typical designs of hearing apparatuses, in particular hearing devices, are behind-the-ear (“BTE”) and in-the-ear (“ITE”) hearing apparatuses. These names are geared to the intended wearing position. As such, behind-the-ear hearing apparatuses have a (main) housing that is worn behind the pinna. A distinction can be drawn here between models whose loudspeaker is arranged in this housing—the sound output to the ear is normally provided by means of a sound tube worn in the auditory canal—and models that have an external loudspeaker placed in the auditory canal. By contrast, in-the-ear hearing apparatuses have a housing that is worn in the pinna or even completely in the auditory canal.

Smart mobile devices are, for example, smartphones, tablets or else so-called “wearables”, e.g. smartwatches (i.e. wristwatches having additional functions, in particular communication capability, Internet connectivity and the like). Smartphones and tablets together with hearing apparatuses can also form a hearing system, for example in order to be able to make adjustments to the hearing apparatus. Since mobile devices such as these may often also include sensitive (in particular personal) data content, they often have a locked state in order to prevent unauthorized access by third parties. In the case of a smartphone or a tablet, this locked state is usually cancelled by way of a numerical code, a pattern (which are normally input on a screen), a fingerprint and sometimes even by way of facial recognition. A disadvantage of this, however, is that inputting a code is associated with effort, a fingerprint could theoretically be taken from the mobile device itself by third parties and facial recognition is hampered, in particular when facemasks (medical respiratory protection or the like) are used.

The invention is based on the object of improving the use of a smart mobile device.

This object is achieved according to the invention by way of a method having the features of claim 1. In addition, this object is achieved according to the invention by way of a hearing apparatus having the features of claim 9. Additionally, this object is achieved according to the invention by way of a hearing system having the features of claim 10. Other embodiments and developments that are advantageous and in some cases inventive by themselves are outlined in the subclaims and the description that follows.

The method according to the invention is used for operating a smart mobile device, in particular a hearing system, that encompasses a mobile device such as this and preferably also a hearing apparatus. The method involves checking for or ascertaining the presence of a device known to the mobile device by means of a radio module of the mobile device and/or the known device in a locked state of the mobile device, in which manual access to the data content thereof is disabled. In the event of the presence of the known device being detected, an ultra-wideband radio connection is used to ascertain whether the known device is within a predefined distance from the mobile device. The locked state of the mobile device is cancelled if the known device is within the predefined distance.

Expressed in another way, the mobile device is unlocked when a known device—determined by means of the ultra-wideband connection, which has preferably already been set up between the mobile device and the known device—is within a predefined distance (specifically a distance limit value). This is advantageous because there is thus no requirement for unlocking by means of a code that has to be input manually, fingerprint recognition or facial recognition. The predefined distance (specifically the predefined distance limit value) is thus used in particular to establish whether the mobile device and the known device are at a distance from one another that suggests that use of the mobile device is intended. By way of example, the known device may be a type of token or the like that is associated with and in particular also carried by a person who is authorized for the unlocking.

Preferably, the known device used is a hearing apparatus, in particular a hearing aid. This has the advantage that the person normally wears this type of device close to the body and, in particular in the case of a hearing aid, it is usually also individually allocated. This increases the likelihood of the person also having the appropriate authorization when the device is present. Misuse is thus comparatively unlikely.

In one preferred method variant, the smart mobile device used is a smartphone. In particular in combination with the hearing apparatus, the unlocking can take place in particular when the person brings the smartphone to in front of their face to interact with it.

In particular, the distance (in particular the distance limit value) from which the mobile device, in particular the smartphone, is activated (unlocked) is predefined on a user-specific basis. Expressed another way, the person can stipulate and thus predefine the distance value (distance limit value) themselves. By way of example, the distance for enabling can thus be chosen to be 30 cm. In this case, the mobile device or smartphone is then activated only when it is within 30 cm of the head of the person and therefore usually in a position in which the person has brought the smartphone to in front of their own eyes. In particular such a, comparatively low, distance limit value, which is optionally chosen to be between approximately (i.e. +/−5 cm) 20 and 60 cm, preferably between 30 and 50 cm, or can expediently be selected in this range from a list, makes it possible to ensure that unlocking by another person who is in the immediate vicinity of the person with the mobile device is prevented. Similarly, accidental unlocking of the smartphone for example in a trouser pocket, jacket pocket or bag of the person is intended to be avoided.

In one preferred method variant, the radio module used is an ultra-wideband transceiver. An ultra-wideband transceiver such as this operates in particular over a frequency bandwidth of at least 500 MHz and/or at least 20% of a center frequency. This allows the ultra-wideband transceiver to transmit using particularly short signal pulses (preferably in the region of less than 10 ns, sometimes in the region around 1 ns), which in turn permits a power draw of a few μW. A particularly high resolution for a distance measurement, in particular by means of signal propagation time measurement, angle of arrival ascertainment and the like, is also possible in this case, however. The distance can thus also be ascertained particularly accurately in the range below one meter, in particular below 50 cm. Center frequency is intended to be understood to mean in particular the median value from the upper and lower cutoff frequencies of the applicable frequency band. By contrast, conventional radio techniques intended for such purposes (narrowband radio or narrowband communication) use much narrower, in particular less than half in terms of size, frequency widths (WLAN for example with a maximum of approximately 160 MHz in the 5 GHz band, otherwise less than 100 MHz; Bluetooth, also with below 100 MHZ). Additionally, the ultra-wideband transceiver is preferably configured to transmit only single signal pulses. In contrast to conventional radio engineering (in particular WLAN and Bluetooth), this uses no modulation of a carrier signal, specifically the carrier frequency thereof, but rather in particular so-called pulse modulation techniques.

In another preferred method variant, the distance of the known device is ascertained by means of so-called two-way ranging (TWR), i.e. in particular on the basis of a two-way communication between the mobile device and the known device. This is expedient in particular for ascertaining the distance between two moving devices.

In one expedient method variant, the known device sends a request to cancel the locked state of the mobile device to the mobile device if the known device is within the predefined distance (in particular distance limit value). This in turn has the advantage that the unlocking is initiated by a two-way communication (in particular beyond the mere distance ascertainment, for example the aforementioned two-way ranging) between the mobile device and the known device. This can increase the security of the unlocking process described here and hereinbelow.

In another expedient method variant, the (optionally further) radio module used to ascertain the presence of the known device is a narrowband transceiver and the ultra-wideband connection is activated in the event of the presence being detected, in particular within a further predefined distance (specifically a further predefined distance limit value). In particular, two radio modules, specifically the narrowband transceiver and also the ultra-wideband transceiver, are used in this variant. The narrowband transceiver is in particular continuously active and couples to a corresponding narrowband transceiver of the known device. Preferably, the or the respective narrowband transceiver is configured to communicate (i.e. to “radio”) on the basis of the Bluetooth Low Energy standard. This allows a particularly low energy consumption to be achieved. Preferably, such a transceiver is always active in the mobile device, in particular the smartphone, and so this results in no or merely negligible additional consumption being added.

In an additional variant, which represents a standalone invention, a payment authorization can also be carried out. This is possible for example by using the mobile device to prepare a payment, for example by means of a near field communication device, in particular by activating a payment application on the smartphone that forms the mobile device and routing said payment application to an appropriate remote station. The authorization can then be provided by bringing the known device, in particular the hearing apparatus, sufficiently close to the smartphone (in a similar manner to the unlocking described hereinabove). Alternatively, there may be a payment application installed on the mobile device (in particular smartphone) of the person who also has the aforementioned hearing apparatus. Said payment application receives from the hearing apparatus information about devices having an ultra-wideband radio module that are near the hearing apparatus. The person using the smartphone and the hearing apparatus can then select the device, in particular the person associated with this device, or the company, who or that is meant to receive the payment. The applicable bank details may already be stored in the payment application or can be obtained by the mobile device.

In one optional embodiment, the mobile device may also be a charger for the hearing apparatus. This charger is preferably in a locked state in which, by way of example, a charging function is deactivated by control means or a lock for a lid is locked. Only when the hearing apparatus approaches the charger to an appropriate degree of proximity is the locked state cancelled.

The hearing apparatus according to the invention comprises the radio module described hereinabove that is configured for the ultra-wideband connection. Additionally, the hearing apparatus comprises a controller (also referred to as a signal processor) that is configured to carry out the method described hereinabove in particular independently, optionally in partnership with the person using the hearing apparatus. In particular, the hearing apparatus is configured to send the aforementioned request to cancel the locked state to the mobile device, in particular if the signal processor ascertains that the mobile device and the hearing apparatus are arranged within the predefined distance from one another.

The hearing system according to the invention comprises the hearing apparatus described hereinabove having the radio module configured for the ultra-wideband connection, and the smart mobile device having the (in particular second) radio module configured for the ultra-wideband connection. The hearing apparatus and/or the mobile device comprise the aforementioned controller that is configured to carry out the method described hereinabove independently, optionally in partnership with the person using the hearing apparatus.

In one preferred configuration, the controller (or at least one of possibly multiple controllers) is formed at least in essence by a microcontroller having a processor and a data memory, in which the functionality for carrying out the method according to the invention is implemented by programming in the form of operating software (firmware), with the result that the method is automatically carried out—possibly in interaction with the user—when the operating software is executed in the microcontroller. Within the context of the invention, the controller may, however, alternatively also be formed by a non-programmable electronic assembly, e.g. an ASIC, in which the functionality for carrying out the method according to the invention is implemented using circuitry means.

The conjunction “and/or” is intended to be understood here and below to mean in particular that the features linked by means of this conjunction may be implemented either jointly or as alternatives to one another.

The advantage of the optional use, described hereinabove, of the narrowband and wideband radio connections is that a narrowband radio connection is usually present anyway and the wideband radio connection then needs to be activated only when it is required. If in particular Bluetooth Low Energy radio engineering is used for the narrowband radio connection, a particularly low power draw can also be achieved in this case.

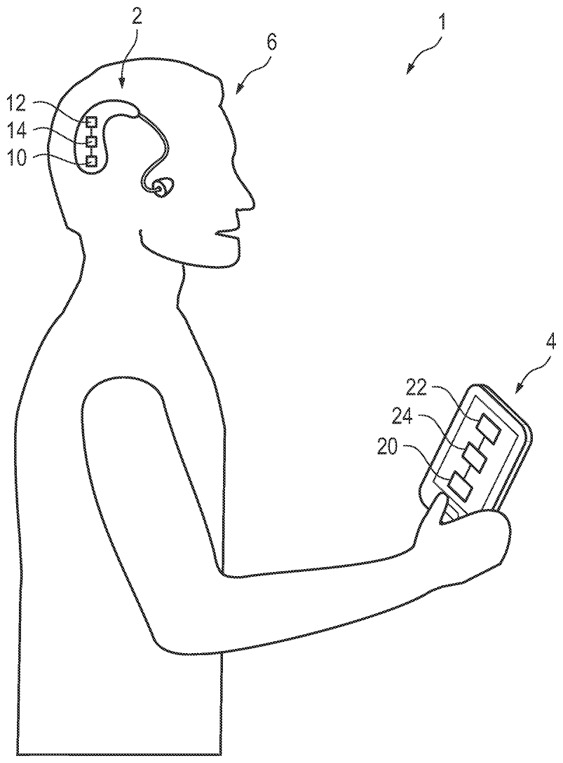

An exemplary embodiment of the invention is explained more thoroughly hereinbelow with reference to a drawing. In the drawing, the single FIG. 1 shows a schematic representation of a hearing system.

FIG. 1 schematically shows a hearing system 1. Said hearing system comprises a hearing apparatus in the form of a hearing aid (shortened to: hearing device 2). Additionally, the hearing system 1 comprises a smart mobile device, in the form of a smartphone 4 here. The hearing device 2 is worn by a person 6 when used as intended.

The hearing device 2 comprises a narrowband radio module 10 and an ultra-wideband radio module 12. In addition, the hearing device 2 comprises a controller 14 (also: signal processor) that is connected to the narrowband radio module 10 and the ultra-wideband radio module 12. The two radio modules 10 and 12 are alternatively also referred to as “transceivers.”

The smartphone 4 likewise comprises a narrowband radio module 20, an ultra-wideband radio module 22 and a controller 24.

The controller 14 or the controller 24 is configured to carry out a method as described more thoroughly hereinbelow. Optionally, both controllers 14 and 24 may also be equally configured to carry out the method.

The method described below is used to operate the hearing system 1, in particular the smartphone 4. Specifically, the method is used to unlock the smartphone 4, i.e. to cancel a locked state of the smartphone 4, which said smartphone normally adopts in response to a user command and/or when a predefined time without input into the smartphone 4 elapses. This is accomplished by ascertaining whether the hearing device 2 that is already known (for example previously coupled by radio) to the smartphone 4 is nearby, for example less than 3 meters, preferably less than 2 meters, away from the smartphone 4. This is accomplished by examining a coupling between the smartphone 4 and the hearing device 2 by way of the narrowband radio modules 10 and 20 thereof. If the hearing device 2 and the smartphone 4 are coupled by way of the narrowband radio modules 10 and 20 thereof, a signal strength that—assuming a free radio link—contains information about the distance between the hearing device 2 and the smartphone 4 can be ascertained for the existing narrowband radio connection.

This distance is compared with a predefined limit value, for example 2 meters, and, if the limit value has been underrun, an ultra-wideband radio connection is initiated by means of the respective ultra-wideband radio modules 12 and 22. The ultra-wideband radio connection is then taken as a basis for more precisely determining a distance between the smartphone 4 and the hearing device 2. This is accomplished by using so-called two-way ranging. To this end, the hearing device 2 transmits a request containing a transmission time to the smartphone 4. The latter transmits a response containing the reception time of the request and the transmission time of the response. The hearing device 2 in turn registers the reception time of the response and transmits a “report” containing at least the transmission time of the request, the reception time of the response and the transmission time of the report. The controller 24 of the smartphone 4 can use these to determine the signal propagation time and therefore also the current distance value between the hearing device 2 and the smartphone 4.

In one variant, the controller 24 of the smartphone 4 compares this current distance value with a (further) predefined limit value, for example 30 or 40 cm. This is usually a typical distance when the person 6 brings the smartphone 4 to their face in order to have a look at something or the like. If the current distance value is identical to or below this further limit value, the controller 24 cancels the locked state of the smartphone 4. Preferably, the hearing device 2 is, to this end, stored in the smartphone 4 (specifically a memory of the smartphone 4) as an authorized known device for cancelling the locked state.

In an alternative method variant, the controller 14 of the hearing device 2 ascertains the current distance value on the basis of the two-way ranging approach described hereinabove and, in the event of the applicable limit value being underrun, transmits an enable or unlock request to the smartphone 4 (for example by means of the narrowband radio module 12).

The two-way ranging described hereinabove can also be initialized by the smartphone 4. The signal propagation of request, response, etc., is then accordingly converse.

The subject matter of the invention is not limited to the exemplary embodiment described above. Rather, other embodiments of the invention can be derived from the description hereinabove by a person skilled in the art.

### LIST OF REFERENCE SIGNS

1 hearing system
2 hearing device
4 smartphone
6 person
10 narrowband radio module
12 ultra-wideband radio module
14 controller
20 narrowband radio module
22 ultra-wideband radio module
24 controller

1-10. (canceled)

11. A method for operating a smart mobile device, the method comprising:
in a locked state of the mobile device, in which manual access to a data content thereof is disabled, checking for, or ascertaining, by way of a radio module whether or not a device that is known to the mobile device is present;
when a presence of the known device is detected, using an ultra-wideband radio connection to ascertain whether the known device is present within a predefined distance from the mobile device; and
if the known device is present within the predefined distance, canceling the locked state of the mobile device.

12. The method according to claim 11, which comprises using the radio module as an ultra-wideband transceiver.

13. The method according to claim 11, wherein the pre-defined distance is predefined on a user-specific basis.

14. The method according to claim 11, wherein the smart mobile device is a smartphone.

15. The method according to claim 11, wherein the known device is a hearing apparatus.

16. The method according to claim 15, wherein the known device is a hearing aid.

17. The method according to claim 11, which comprises ascertaining the distance of the known device based on two-way communication between the mobile device and the known device.

18. The method according to claim 11, which comprises sending a request by the known device to cancel the locked state of the mobile device to the mobile device when the known device is within the predefined distance.

19. The method according to claim 11, wherein the radio module used to ascertain the presence of the known device is a narrowband transceiver and the ultra-wideband connection is activated when the presence is detected within a given distance.

20. The method according to claim 19, wherein the given distance is a further predefined distance.

21. A hearing apparatus, comprising a radio module configured for an ultra-wideband radio connection, and a hearing device with a controller configured to carry out the method according to claim 11.

22. The hearing apparatus according to claim 21, wherein the hearing device is a hearing aid.

23. A hearing system, comprising:
a hearing apparatus having a first radio module configured for an ultra-wideband radio connection;
a smart mobile device having a second radio module configured for the ultra-wideband radio connection; and
wherein at least one of said hearing apparatus or said mobile device has a controller configured to carry out the method according to claim 11.
